(19) United States
(12) Patent Application Publication
(10) Pub. No.: US 2010/0012709 A1
(43) Pub. Date: Jan. 21, 2010

(54) Reflow furnace

(76) Inventors: Takayuki Nikaido, Chiba (JP); Tsutomu Hiyama, Tokyo (JP)

Correspondence Address: MICHAEL TOBIAS, 1629 K ST NW, SUITE 300, WASHINGTON, DC, 20006, US

(21) Appl. No.: 10/585,328

(22) PCT Filed: Dec. 27, 2004
(86) PCT No.: PCT/JP04/19498

§ 371 Date: May 11, 2009

(30) Foreign Application Priority Data
Jan. 7, 2004 (JP) 2004-001523

(51) Int. Cl. B23K 31/02; B23K 3/04

(52) U.S. Cl. 228/256; 228/20.1; 228/19

(57) ABSTRACT

A reflow furnace includes a suction pipe extending within a heating region along a rail on which a conveyor travels. Suction ports are formed on the inner side of the suction pipe. Flux fumes inside the reflow furnace are sucked into the suction ports and transported to the exterior of a tunnel of the furnace by the suction pipe. The flux fumes are removed by a flux fumes removal apparatus on the exterior of the tunnel, and cleaned gas is returned to the interior of the tunnel at the entrance and the exit of the tunnel, where it forms air curtains which prevent the ingress of outside air.

### TECHNICAL FIELD

This invention relates to a reflow furnace for soldering surface mounted devices to a printed circuit board using a solder paste.

### BACKGROUND ART

A solder paste used for soldering in a reflow furnace is a viscous soldering material comprising solder powder and a pasty flux. When soldering a surface mounted device (SMD) to a printed circuit board using a solder paste, a metal mask having holes formed in the same locations as the portions to be soldered of the printed circuit board is placed atop the printed circuit board so that the holes and the portions to be soldered coincide, a solder paste is then placed atop the metal mask, and the solder paste is wiped with a squeegee to fill the holes in the metal mask with the solder paste. When the metal mask is then moved upwards from the printed circuit board, the solder paste is applied by printing to the portions to be soldered of the printed circuit board. Prescribed SMD's are then placed on the portions of the printed circuit board where the solder paste was applied, and the printed circuit board is then transported inside a reflow furnace by a conveyor of the reflow furnace and soldering is carried out.

A reflow furnace for carrying out soldering of printed circuit boards comprises a preheating zone, a main heating zone, a cooling zone arranged in succession in the direction from the entrance to the exit of the furnace. A conveyor travels along these zones. As a printed circuit board is being transported by the conveyor, it passes through the preheating zone, the main heating zone, and the cooling zone and soldering is carried out.

The preheating zone of a reflow furnace heats a printed circuit board to 100-150° C. so as to evaporate solvents contained in the solder paste, it prevents sudden boiling of the solvent during high temperature heating in the next step in the main heating zone, it alleviates thermal shock to the printed circuit board and SMD's during high temperature heating, and it activates the flux to remove oxides and contaminants adhering to portions to be soldered and electrodes of the SMD's and thereby cleans them.

In the main heating zone, the temperature reaches at least the melting point of the solder powder in the solder paste, so the solder powder in the solder paste applied to the printed circuit board is melted, and the portions to be soldered of the printed circuit board are soldered to the electrodes of the SMD's.

In the cooling zone, cold air is blown at a printed circuit board which was heated to a high temperature in the main heating zone, molten solder is solidified so that soldered portions will not be destroyed by vibrations or impacts, and the printed circuit board and the SMD's are rapidly cooled so as to eliminate the effects of residual heat.

An activator is an indispensable component of a flux of a solder paste. An activator performs cleaning by reducing and removing oxides even when the portions to be soldered of a printed circuit board or electrodes of SMD's are oxidized when they are heated to a high temperature at the time of soldering. As the amount of an activator which is added to a solder paste increases, solderability is improved and defects are decreased. However, if soldering is carried out with a solder paste containing a large amount of an activator, flux residue which adheres to soldered portions after soldering absorbs moisture and becomes an electrolyte, and it corrodes soldered portions and reduces insulation resistance. Therefore, printed circuit boards used in communications equipment, computers, and the like which require reliability have been cleaned to remove flux residue after soldering using a solder paste. Cleaning of flux residue has been carried out using a cleaning agent such as trichloroethylene, Freon, or alcohol, but these cleaning agents cause a breakdown of the ozone layer surrounding the earth and cause global warming, so use thereof is being regulated. Therefore, at present, a solder paste which does not require cleaning after soldering, i.e., a no-clean solder paste has come to be used. A no-clean solder paste contains only a small amount of an activator, and the amount of flux residue remaining after soldering is extremely small, so it does not cause problems such as corrosion or a decrease in insulation resistance even if cleaning is not carried out.

Since no-clean solder paste contains only a small amount of an activator, if soldering is carried out in an air reflow furnace in which oxygen is present, oxides on soldered portions which oxidize at the time of heating cannot be completely removed by reduction. Accordingly, a no-clean solder paste not only produces soldering defects, but it also cannot sufficiently reduce oxidized solder powder, and minute solder balls end up being formed. However, even with a no-clean solder paste, if soldering is carried out in a reflow furnace containing an inert atmosphere in which oxygen is not present, portions being soldered do not oxidize at the time of heating, so it is possible to carry out soldering without soldering defects or formation of minute solder balls. Accordingly, recently, in the electronics equipment industry, reflow furnaces using an inert atmosphere have come to be much used.

With an inert atmosphere reflow furnace, the lower the oxygen concentration in the furnace, the more effective is the furnace at preventing soldering defects. In an inert atmosphere reflow furnace, a device such as a labyrinth has been installed on the exit and entrance so that air will not penetrate from the exterior of the furnace, or turbulence of hot gas blown inside the furnace has been suppressed so as to prevent penetration of air from the exterior.

In general, in an inert atmosphere reflow furnace, inert gas is introduced into the furnace from a gas cylinder or an inert gas generating apparatus or the like disposed on the exterior of the furnace, but if new inert gas is constantly introduced, a large amount of inert gas is consumed, and running costs become high. Therefore, inert gas in a furnace is cleaned and reused. Cleaning of inert gas involves removing solvent vapors and flux fumes produced by solder paste at the time of soldering.

When a solder paste is heated in a reflow furnace, solvents in the solder paste vaporize in the preheating zone, and the flux is heated to a high temperature in the main heating zone, so the flux breaks down and becomes flux fumes. If solvents and flux fumes (collectively referred to below as flux fumes) which evaporate in this manner adhere to structural portions inside a reflow furnace, they condense on these portions and harden. If flux fumes which have hardened accumulate over a long period, they drip onto printed circuit boards at the time of soldering and contaminate the expensive printed circuit boards or SMD's, or they interfere with the smooth operation of a conveyor. Therefore, in the past, there were many proposals of reflow furnaces equipped with a flux fumes removal apparatus. See JP H1-305594 A, JP H4-13474 A, JP H4-46667 A, JP H4-251661 A, JP H5-50218 A, JP H9-307224 A, JP H10-335807 A, and Japanese Published Unexamined Utility Model Application H5-93079.

### SUMMARY OF THE INVENTION

In a reflow furnace equipped with a conventional flux fumes removal apparatus, there is insufficient suction for sending flux fumes to the removal apparatus. In addition, when inert gas which was cleaned by the removal apparatus is returned to the inside of the furnace, there is sometimes entry of outside air into the furnace. This invention provides a reflow furnace which not only efficiently carries out suction of flux fumes which are formed inside the furnace but which also does not experience influx of outside air into the furnace when inert gas which was cleaned in the removal apparatus is returned to the furnace.

The present inventors perceived that when smoke is exhausted, it can be efficiently exhausted if a suction portion is provided in the vicinity of the origin of the smoke, and that the flow of air can be prevented by providing an air curtain at an entry and exit, and they thereby completed the present invention.

The present invention is a reflow furnace in which flux fumes which are formed inside a reflow furnace are led by a pipe to the exterior of a tunnel of the reflow furnace together with an inert gas, and after flux fumes are removed by a flux fumes removal apparatus installed on the exterior of the tunnel of the reflow furnace, the inert gas is again returned to the interior of the reflow furnace. A suction pipe for flux fumes is provided along a rail for a conveyor at least over the entirety of a heating zone. A plurality of suction ports are formed in the inner side of the suction pipe, and the suction pipe is connected to an inlet of the flux fumes removal apparatus by an outflow pipe. Blowoff nozzles are installed above and below the entrance and exit of the reflow furnace, and the blowoff nozzles are connected to the outlet of the removal apparatus.

In a reflow furnace according to the present invention, flux fumes which are formed in the furnace can be efficiently transported to the outside of the furnace and cleaned, so the flux fumes do not adhere to the furnace walls or the conveyor, and the problem of solidified flux fumes falling down does not occur. In addition, because a reflow furnace according to the present invention introduces cleaned inert gas into the furnace at the entrance and exit, the inert gas becomes an air curtain at the entrance and exit, inflow of air from outside the furnace is prevented, and the concentration of oxygen inside the furnace can be prevented from increasing.

When a printed circuit board is heated inside a furnace, flux fumes are formed by the solder paste which was applied to the printed circuit board. A suction port for flux fumes is preferably placed as close as possible to the printed circuit board. In the present invention, suction ports for flux fumes are placed in the vicinity of a conveyor and preferably above a rail of the conveyor. Openings are formed in suitable locations of a long rectangular pipe as the suction ports, and the pipe is installed above the rail.

A suction pipe for sucking flux fumes needs to extend over the entire heating zone, i.e., over the preheating zone and the main heating zone. In the preheating zone, solvent evaporates from solder paste, and in the main heating zone, flux vaporizes. Therefore, sucking of these vapors and fumes needs to be given first priority. However, if the suction pipe extends to the cooling zone, it is further effective at sucking flux fumes inside the furnace. This is because flux fumes which are formed in the main heating zone are sometimes carried over to the cooling zone, so if suction of these flux fumes is carried out, nearly all the fumes inside the furnace can be sucked out.

### BRIEF DESCRIPTION OF THE DRAWINGS

FIG. 1 is a front cross-sectional view of a reflow furnace of the present invention.

FIG. 2 is a plan cross-sectional view of the conveying apparatus of the furnace of FIG. 1.

FIG. 3 is a cross-sectional view taken along line A-A of FIG. 2.

FIG. 4 is an enlarged perspective view of principal portions of FIG. 3.

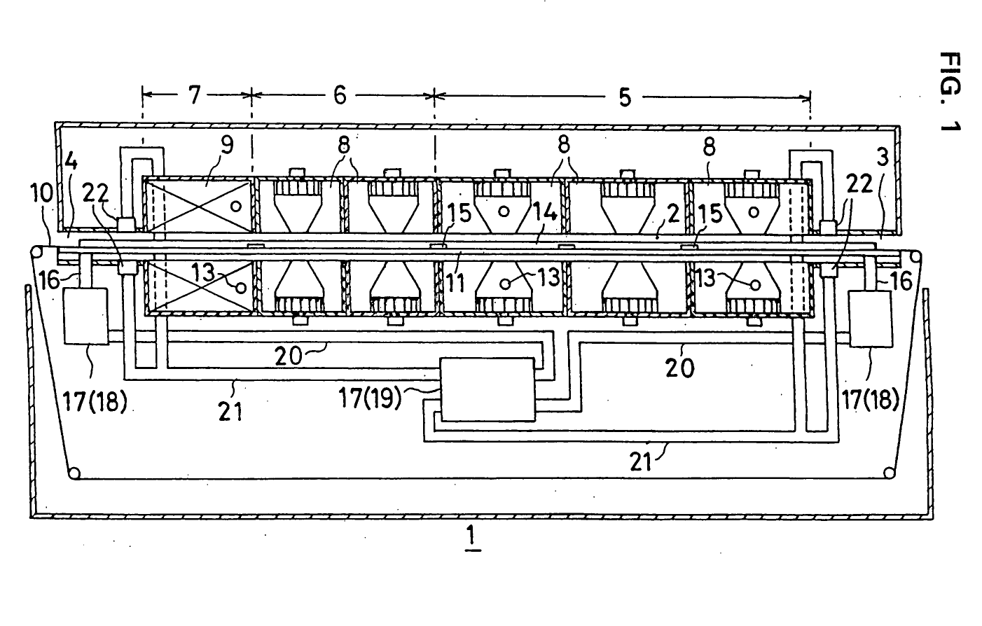

### DESCRIPTION OF PREFERRED EMBODIMENTS

Below, a reflow furnace according to the present invention will be described based on the drawings. As shown in the drawings, the reflow furnace 1 has a tunnel 2 formed in its lengthwise direction. The inside of the tunnel is formed into a preheating zone 5, a main heating zone 6, and a cooling zone 7 which are arranged in series from an entrance 3 towards an exit 4. Heaters 8 of the type which blow hot air are installed in the upper and lower portions of the preheating zone 5 and the main heating zone 6. Cooling mechanisms 9, 9 are installed in the upper and lower portions of the cooling zone 5.

A pair of conveyors 10, 10 runs inside the tunnel 2 from the entrance 3 towards the exit 4. The conveyors 10 travel atop rails 11. A large number of pins 12 which extend toward each other project from the pairs of conveyors 10, 10, and a printed circuit board P is disposed atop the pins and is transported inside the tunnel 2.

Inert gas supply ports 13 are installed in suitable locations inside the heaters 8 for blowing hot air. The inert gas supply ports are connected to an unillustrated inert gas supply such as a nitrogen gas cylinder or a nitrogen gas tank on the outside of the reflow furnace.

Rectangular suction pipes 14 are installed along the rails 11 of the conveyors. A plurality of suction ports 15 are formed on the inner sides of the suction pipes, i.e., on the sides facing a printed circuit board being transported. The length of the suction pipes 14 needs to be such that they extend to at least the preheating zone 5 and the main heating zone 6 which are the portions where a printed circuit board is actually heated, but they may extend to the cooling zone. Outflow pipes 16, 16 are connected to both ends of the suction pipes 14 and to a removal apparatus 17 which removes flux fumes.

The flux fumes removal apparatus 17 comprises filter portions 18 and an aggregating portion 19. The filter portions 18 and the aggregating portion 19 are connected by removal pipes 20. A filter is installed inside each filter portion 18. Most of the flux fumes which are sucked by the suction pipes 14 are adsorbed by the filters and removed. The aggregating portion 19 is equipped with a blower, and water-cooled fins are installed in its interior. The blower sucks in gas through the suction pipes 14, the outflow pipes 16, the filter portions 18, and the removal pipes 20, and flux fumes which could not be adsorbed and removed by the filter portions 18 are made to contact the water-cooled fins and are thereby aggregated and adhered to the fins and recovered.

Outflow pipes 21, 21 are connected to outlets of the aggregating portion 19. The outflow pipes are connected to blowoff nozzles 22 installed in the upper and lower portions of the entrance and the exit of the tunnel.

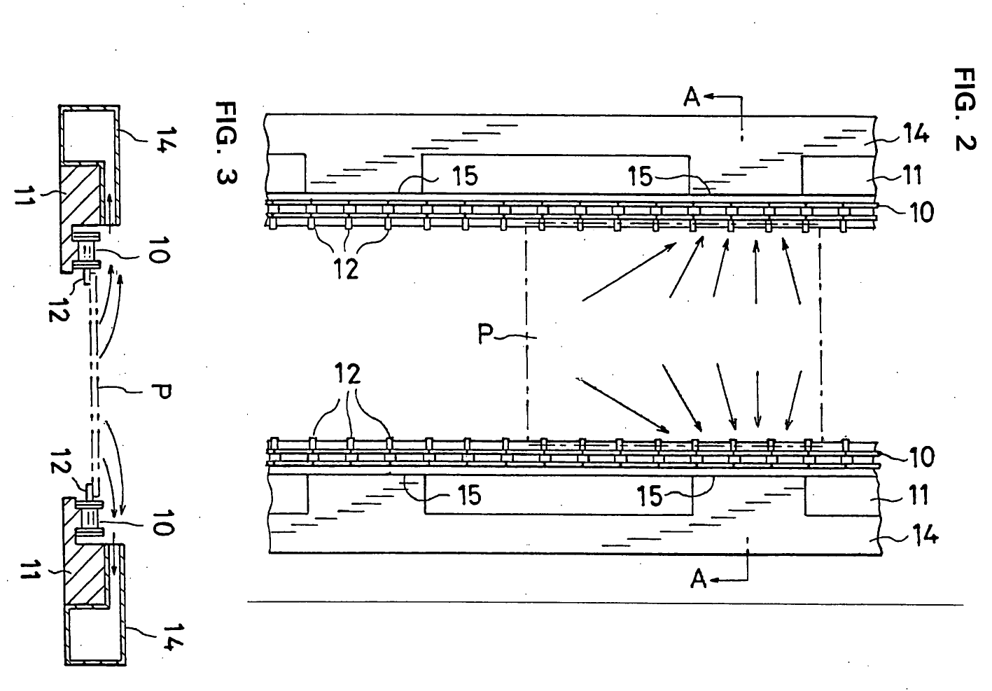

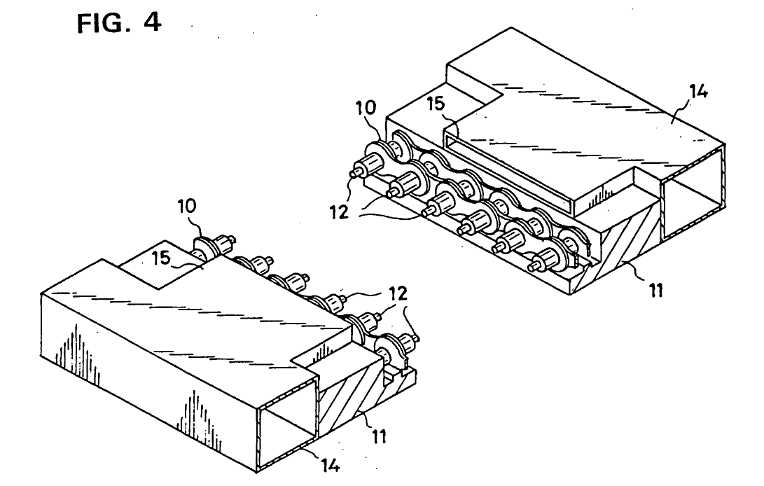

The operation of a reflow furnace having the above-described structure will be explained. A printed circuit board P is disposed on the conveyors 10 from the entrance 3 and carried into the tunnel 2. The printed circuit board P is heated by the heaters 8 for blowing hot air in the preheating zone 5, solvents in the solder paste are evaporated here, and preheating is carried out in order to protect the printed circuit board and electronic parts against thermal shock. The solvent which is evaporated here is sucked into the suction ports 15 which open in the vicinity of the conveyors 10 as shown by arrows in FIGS. 2 and 3.

The printed circuit board P which was preheated in the preheating zone 5 is next transported to the main heating zone 6, and here solder powder in the solder paste which is heated to a high temperature melts and spreads and wets the portions to be soldered. At this time, rosin, activators, thixotropic agents, and the like in the solder paste become flux fumes, and the flux fumes are sucked into the suction ports 15 which open in the vicinity of the conveyors 10.

The gasified solvent and flux fumes which are sucked into the suction ports 15 pass from the suction pipes 14 to the outflow pipes 16 and enter the filter portions 18 of the removal apparatus. Although the flux fumes are gases, they are a collection of fine particles, so the flux fumes which enter the filter portion adhere to the filter and are almost entirely removed. Flux fumes from which particles could not be completely removed are transferred by the removal pipe 20 to the aggregating portion 19, and here they contact the water-cooled fins and aggregate and are completely removed. The filters to which a large amount of flux fumes has adhered are removed from the filter portions and discarded or incinerated, and the flux fumes which adhere to the water-cooled fins in the aggregating portion are recovered in a vessel at the bottom portion and disposed of as industrial waste.

A reflow furnace according to the present invention is suitable for use as an inert atmosphere reflow furnace, but it can of course be used as an air reflow furnace not using an inert gas. Flux fumes are also formed in an air reflow furnace, but by cleaning hot air inside the furnace in a removal apparatus on the exterior of a tunnel of the furnace and then circulating it to the to the interior of the tunnel, warmed air can be reused, resulting in conservation of resources.

1. (canceled)

2. A reflow furnace comprising a tunnel having an entrance and an exit, a heating zone disposed between the entrance and exit, a conveyor for printed circuit boards extending through the heating zone, a suction pipe extending alongside the conveyor within the heating zone and having a plurality of suction ports formed therein, a flux fumes removal apparatus disposed on the exterior of the tunnel and fluidly communicating with the suction pipe, and a plurality of nozzles disposed at the entrance and exit of the tunnel and fluidly communicating with the flux fumes removal apparatus.

3. A reflow furnace as claimed in claim 2 wherein the flux fumes removal apparatus comprises a filter and an aggregating portion which cools flux fumes which have passed through the filter.

4. A reflow furnace as claimed in claim 2 wherein the conveyor includes a rail, and the suction ports are disposed above the rail.

5. A reflow furnace as claimed in claim 2 wherein gas discharged from the nozzles at the entrance and exit forms air curtains at the entrance and exit.

6. A reflow furnace as claimed in claim 2 wherein the suction pipe extends over an entire length of the heating zone.

7. A reflow furnace as claimed in claim 2 including a cooling zone, wherein the suction pipe extends into the cooling zone.

8. A reflow furnace as claimed in claim 2 including first and second opposing conveyors capable of supporting opposite widthwise sides of a printed circuit board, and first and section suction pipes extending alongside the first and second conveyors, respectively, each of the suction pipes having a plurality of suction ports facing towards the other suction pipe.

9. A reflow furnace comprising a tunnel, a conveying apparatus which conveys an object to be soldered between first and second ends of the tunnel, a heater which heats an object to be soldered as it passes through the tunnel, a flux fumes removal apparatus disposed on the exterior of the tunnel and having an inlet fluidly communicating with the interior of the tunnel and an outlet, and a nozzle disposed at an end of the tunnel and fluidly communicating with the outlet of the flux fumes removal apparatus, the nozzle receiving cleaned gas from the flux fumes removal apparatus and discharging the cleaned gas to form an air curtain.

10. A method of operating a reflow furnace comprising:
transporting a printed circuit board on a conveyor through a heating zone of a tunnel of a reflow furnace containing a gas atmosphere;
heating the printed circuit board within the heating zone to generate flux fumes;
sucking a mixture of gas in the gas atmosphere and the flux fumes from the heating zone to an exterior of the tunnel;
removing flux fumes from the mixture to obtain cleaned gas; and
blowing the cleaned gas from a nozzle at an end of the tunnel to form an air curtain.

11. A method as claimed in claim 10 including sucking the mixture of gas and flux fumes through suction ports in a suction pipe extending alongside the conveyor inside the heating zone.

12. A method as claimed in claim 10 including blowing the cleaned gas from a nozzle at a first end and a nozzle at the second end of the tunnel to form an air curtain at each end of the tunnel.
